(19) United States
(12) Patent Application Publication
(10) Pub. No.: US 2025/0377803 A1
(43) Pub. Date: Dec. 11, 2025

(54) MEMBRANE: ACCELERATING DATABASE ANALYTICS WITH DRAM-PIM FILTERING

(71) Applicant: University of Virginia Patent Foundation, Charlottesville, VA (US)

(72) Inventors: Kevin Skadron, Charlottesville, VA (US); Lingxi Wu, San Jose, CA (US); Akhil Shekar, Charlottesville, VA (US); Yimin Gao, Charlottesville, VA (US)

(21) Appl. No.: 19/233,680

(22) Filed: Jun. 10, 2025

Related U.S. Application Data
(60) Provisional application No. 63/658,604, filed on Jun. 11, 2024.

(51) Int. Cl. G06F 3/06

(52) U.S. Cl. CPC G06F 3/0613; G06F 3/0659; G06F 3/0673

(57) ABSTRACT

A bank-level dynamic random access memory (DRAM) process-in-memory (DRAM-PIM) filtering architecture is provided to accelerate database online analytical processing (OLAP) queries. Also, sub-array-level dynamic random access memory (DRAM) process-in-memory (DRAM-PIM) filtering architectures are provided to accelerate database online analytical processing (OLAP) queries.

### CROSS-REFERENCE TO RELATED APPLICATIONS

This application claims the benefit of priority to provisional application 63/658,604, which was filed on Jun. 11, 2024. The entire contents of provisional application 63/658,604 are incorporated herein by reference.

### STATEMENT REGARDING FEDERALLY SPONSORED RESEARCH OR DEVELOPMENT

This invention was made with government support under 2312740 awarded by the National Science Foundation. The government has certain rights in the invention.

### BACKGROUND

The present disclosure relates to data analytics and, in particular, to accelerating data analytics with dynamic random access memory process-in-memory (DRAM-PIM) filtering.

Online Analytical Processing (OLAP) systems are essential for extracting insights from large datasets, enabling businesses and other entities to generate key performance indicators (KPIs), live dashboards and summary reports. These systems rely on complex SQL queries to filter, join, aggregate and sort data stored in vast enterprise databases, which typically include large fact tables and smaller dimension tables. Fact tables store primary entities, such as orders, while dimension tables provide additional context, such as customer or product details. OLAP workloads are read-intensive and often memory-bound, as they involve scanning large tables and performing simple operations like comparisons. The columnar data layout, where fields are stored consecutively, enhances spatial locality but still suffers from a memory wall (i.e., a bottleneck caused by the disparity between memory density growth and bus speed improvements).

### SUMMARY

According to an aspect of the disclosure, a bank-level dynamic random access memory (DRAM) process-in-memory (DRAM-PIM) filtering architecture is provided to accelerate database online analytical processing (OLAP) queries. The bank-level DRAM-PIM filtering architecture includes a DRAM chip including multiple memory banks. Each memory bank includes multiple sub-arrays in which data is stored in horizontal layouts, with each byte present in a same row of the corresponding one of the multiple sub-arrays, a per-bank global data bus, by which the data of one sub-array at a time flows relative to the memory bank and a bank-level filtering unit (BFU) configured to perform filtering operations on data fetched from one of the multiple sub-arrays to the memory bank.

In accordance with at least one or more additional and/or alternative embodiments, the BFU includes a reconfigurable comparator block (RCB), which is receptive of the data of the one sub-array at the time and filtering predicates, and which is configured to generate an output of elements of the data matching the filtering predicates.

In accordance with at least one or more additional and/or alternative embodiments, the RCB is supportive of equality checking.

In accordance with at least one or more additional and/or alternative embodiments, the RCB is supportive of range checking.

In accordance with at least one or more additional and/or alternative embodiments, the BFU further includes a scratchpad memory to store the output as a bitmap.

In accordance with at least one or more additional and/or alternative embodiments, the BFU further includes a multiple filtering predicate loop.

In accordance with at least one or more additional and/or alternative embodiments, the bank-level DRAM-PIP filtering architecture further including a memory controller coupled to the DRAM chip and including a de-interleaving unit configured to swizzle bytes in each word such that an entirety of each word is stored on the DRAM chip.

According to an aspect of the disclosure, a sub-array-level dynamic random access memory (DRAM) process-in-memory (DRAM-PIM) filtering architecture is provided to accelerate database online analytical processing (OLAP) queries. The sub-array-level DRAM-PIM filtering architecture includes a DRAM chip includes multiple memory banks. Each memory bank includes multiple sub-array pairs, each sub-array having data stored thereon in a vertical layout, with each bit stored in a different row and in a same column of the sub-array, and a per-bank global data bus, by which data of one sub-array at a time flows relative to the memory bank. Each of the multiple sub-array pairs includes a sub-array-level filtering unit (SFU) including a bit-serial comparison circuit configured to perform filtering operations with respect to the associated one of the multiple sub-array pairs.

In accordance with at least one or more additional and/or alternative embodiments, the bit-serial comparison circuit is configured to compare an attribute against a filtering predicate in a bit-serial manner, starting from a most significant bit (MSB) to a least significant bit (LSB).

In accordance with at least one or more additional and/or alternative embodiments, the bit-serial comparison circuit is configured to perform a relational comparison between a block of table entries and a filtering predicate value.

In accordance with at least one or more additional and/or alternative embodiments, the bit-serial comparison circuit is configured to reset set bit flip flops and register bit flip-flops to zero, once a mismatch is detected between first and second input bits, a set bit goes to high and latches itself and a current register bit is locked and after all sequential row activations, final values of each set bit and each register bit determine a comparison output by reference to a truth table.

In accordance with at least one or more additional and/or alternative embodiments, the bit-serial comparison circuit is configured to handle an equal-to case.

In accordance with at least one or more additional and/or alternative embodiments, the bit-serial comparison circuit is configured to handle a greater-than case.

In accordance with at least one or more additional and/or alternative embodiments, the bit-serial comparison circuit is configured to handle a less-than case.

In accordance with at least one or more additional and/or alternative embodiments, the sub-array-level DRAM-PIP filtering architecture further includes a memory controller coupled to the DRAM chip and including a de-interleaving unit configured to swizzle bytes in each word such that an entirety of each word is stored on the DRAM chip.

According to an aspect of the disclosure, a sub-array-level dynamic random access memory (DRAM) process-in-memory (DRAM-PIM) filtering architecture is provided to accelerate database online analytical processing (OLAP) queries. The sub-array-level DRAM-PIM filtering architecture includes a DRAM chip including multiple memory banks. Each memory bank includes multiple sub-arrays, each having data stored thereon in a horizontal layout, with each byte present in a same row of the corresponding one of the multiple sub-arrays, and a per-bank global data bus, by which data of one sub-array at a time flows relative to the memory bank. Each of the multiple sub-arrays includes a sub-array-level filtering unit (SFU) including an element-serial bit-parallel comparison circuit configured to perform filtering operations with respect to the associated one of the multiple sub-arrays.

In accordance with at least one or more additional and/or alternative embodiments, the element-serial bit-parallel comparison circuit includes a comparison unit.

In accordance with at least one or more additional and/or alternative embodiments, individual data elements stored in the multiple sub-arrays are accessed sequentially and fed into the comparison unit.

In accordance with at least one or more additional and/or alternative embodiments, the element-serial bit-parallel comparison circuit further includes an instruction buffer configured to convey information as to which sub-array column is to be accessed for an operation and a type of comparison operation to be performed.

In accordance with at least one or more additional and/or alternative embodiments, the sub-array-level DRAM-PIP filtering architecture further includes a memory controller coupled to the DRAM chip and including a de-interleaving unit configured to swizzle bytes in each word such that an entirety of each word is stored on the DRAM chip.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a schematic diagram of a bank-level dynamic random access memory (DRAM) process-in-memory (DRAM-PIM) filtering architecture in accordance with embodiments;

FIG. 2 is a schematic diagram of a sub-array-level dynamic random access memory (DRAM) process-in-memory (DRAM-PIM) filtering architecture in accordance with embodiments;

FIGS. 3A-3C are schematic diagrams of operations of a bit-serial comparison circuit of a sub-array-level filtering unit (SFU) of the sub-array-level dynamic random access memory (DRAM) process-in-memory (DRAM-PIM) filtering architecture of FIG. 2 in accordance with embodiments;

FIG. 4 is a schematic diagram of an element-serial bit-parallel comparison circuit of a sub-array-level dynamic random access memory (DRAM) process-in-memory (DRAM-PIM) filtering architecture in accordance with embodiments; and

FIGS. 5A and 5B are illustrations of a de-interleaving unit for use with the bank-level dynamic random access memory (DRAM) process-in-memory (DRAM-PIM) filtering architecture of FIG. 1 and the sub-array-level dynamic random access memory (DRAM) process-in-memory (DRAM-PIM) filtering architecture of FIGS. 2-4 in accordance with embodiments.

### DETAILED DESCRIPTION

DRAM plays a pivotal role in OLAP systems, serving as the primary memory for executing data-intensive queries. DRAM is hierarchically organized into channels, ranks, banks and subarrays, each offering varying degrees of parallelism. Channels operate independently, allowing concurrent read/write operations, while ranks include multiple DRAM chips that contribute to the memory bus. Banks within each rank provide additional parallelism, but their shared data-paths limit simultaneous data transfers. Subarrays, the smallest organizational unit, contain rows and columns of data, with row buffers enabling efficient access to specific rows. Despite this hierarchical organization, traditional architectures require substantial data transfers between the CPU and memory, creating inefficiencies due to bottlenecks. The bottlenecks arise from the disparity between the growth in memory density and the slower improvements in memory bus speed, which limits the throughput and latency of OLAP workloads.

OLAP workloads are inherently memory-bound, as they involve scanning large tables and performing simple operations, such as comparisons, on individual fields. These workloads exhibit low computational density per byte of input data, making them ideal candidates for near-data processing. Processing-in-Memory (PIM) architectures address the memory wall by enabling computation directly within the memory hierarchy, reducing data movement and improving query performance. PIM architectures leverage the inherent parallelism of DRAM to accelerate filtering operations, which are memory-intensive and parallel. Filtering, a core operation in OLAP systems, involves evaluating filtering predicates on individual columns to identify rows that satisfy specific conditions. For example, a query may filter records where a date field falls within a specified range. By performing these filtering operations within the memory hierarchy, PIM architectures can significantly reduce the volume of data transferred to the CPU, thereby alleviating the bottleneck.

The suitability of filtering for PIM acceleration is underscored by its alignment with key PIM amenability criteria. Filtering is memory-bound, as it streams through entire tables without revisiting non-matching records, and exhibits low cache reuse due to its sequential access pattern. Additionally, filtering operations are localized within individual banks or subarrays, minimizing costly inter-bank or inter-rank data transfers. Filtering also benefits from memory-aligned data parallelism, as columnar data layouts allow simultaneous processing of rows across multiple banks or subarrays. These characteristics make filtering an ideal candidate for PIM acceleration, particularly in OLAP systems where filtering often dominates query execution time.

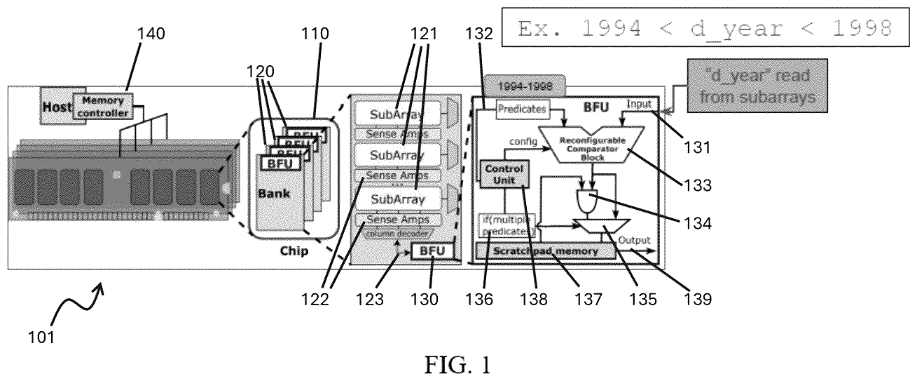

With reference to FIG. 1, a bank-level DRAM-PIM filtering architecture 101 is provided to accelerate database OLAP queries. The bank-level DRAM-PIM filtering architecture 101 includes a DRAM chip 110 including multiple memory banks 120. Each memory bank 120 includes multiple (i.e., 8-16) sub-arrays 121 in which data is stored in horizontal layouts, with each byte present in a same row of the corresponding one of the multiple sub-arrays 121, sense amplifiers 122 for each of the multiple sub-arrays 121, a per-bank global data bus 123, by which the data of one sub-array 121 at a time flows into and out of the memory bank 120 and a bank-level filtering unit (BFU) 130. The BFU 130 is configured to perform filtering operations on data fetched from one of the multiple sub-arrays 121 to the memory bank 120.

The BFU 130 is a specialized processing element designed to accelerate filtering operations. The BFU 130 can be strategically placed at a bank interface, where it connects to the per-bank global data bus 123 and performs filtering operations on data retrieved from the sub-arrays 121. By offloading filtering tasks to the BFU 130, the bank-level DRAM-PIM architecture 101 reduces the need for data movement between the DRAM chip 110 and a CPU, thereby alleviating memory bottlenecks and improving query performances.

The BFU 130 includes an input line 131, a filtering predicate line 132, a reconfigurable comparator block (RCB) 133, an AND gate 134, a multiplexer 135, a multiple filtering predicates logic loop 136, a scratchpad memory 137 where outputs from the RCB 133 are stored as bitmaps, a control unit 138 and an output line 139. The RCB 133 is receptive of the data of the one sub-array 121 at a time via the input line 131 and filtering predicates via the filtering predicate line 132 and is configured to generate an output of elements of the data matching the filtering predicates. This output proceeds directly through the AND gate 134 and/or the multiplexer 135 to the scratchpad memory 137 and the output line 139. The multiple filtering predicates logic loop 136 allows for OLAP queries with more than one filtering predicate. The control unit 138 controls various operations of the components of the BFU 130. The RCB 133 can be supportive equality checking and/or range checking for various types of OLAP queries.

In an exemplary case, a filtering predicate such as “1994<d_year<1998” is evaluated. In this case, d_year values are stored in sub-arrays 121 and are read out one at a time and are fed into the RCB 133 sequentially. The filtering predicate values (1994, 1998) are pre-programmed. The resultant bitmaps (of 1s and 0s is stored in the scratchpad memory 137).

The bank-level DRAM-PIM filtering architecture 101 can further include a memory controller 140. The memory controller 140 is coupled to the DRAM chip 110 and can include a de-interleaving unit (to be described below) configured to swizzle bytes in each word such that an entirety of each word is stored on the DRAM chip 110.

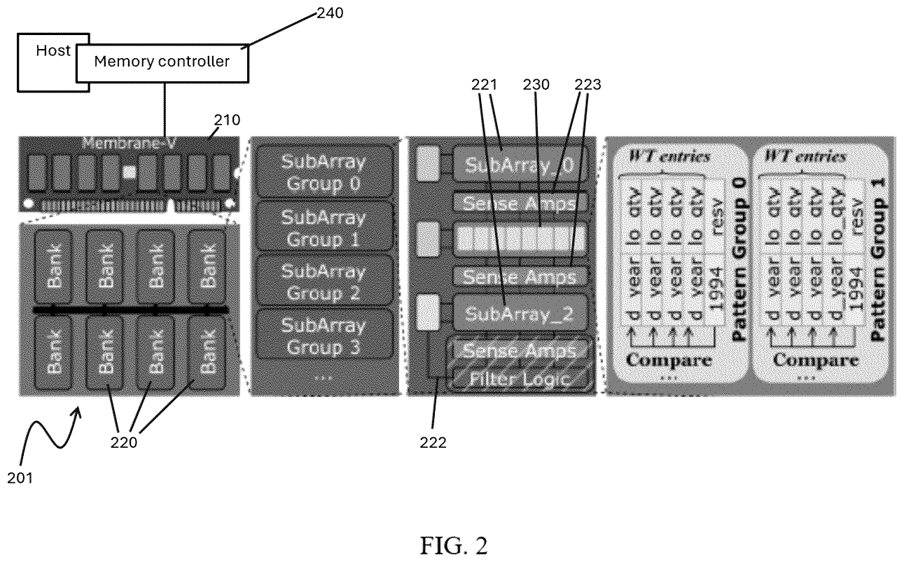

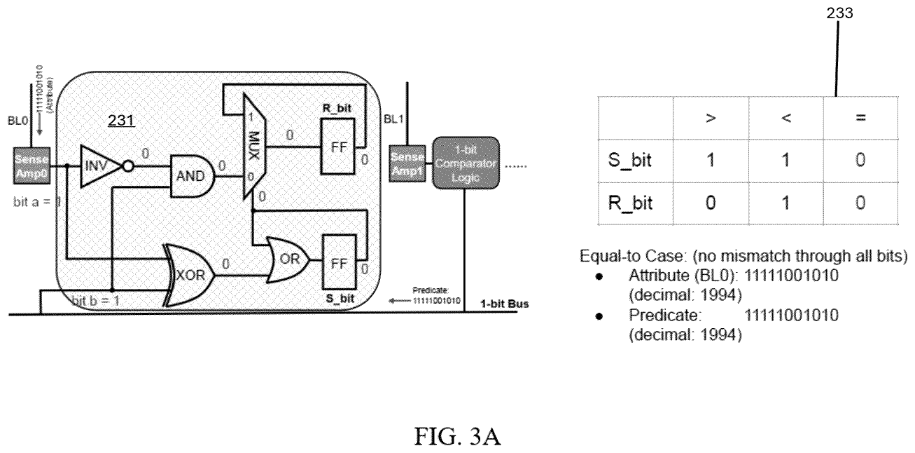

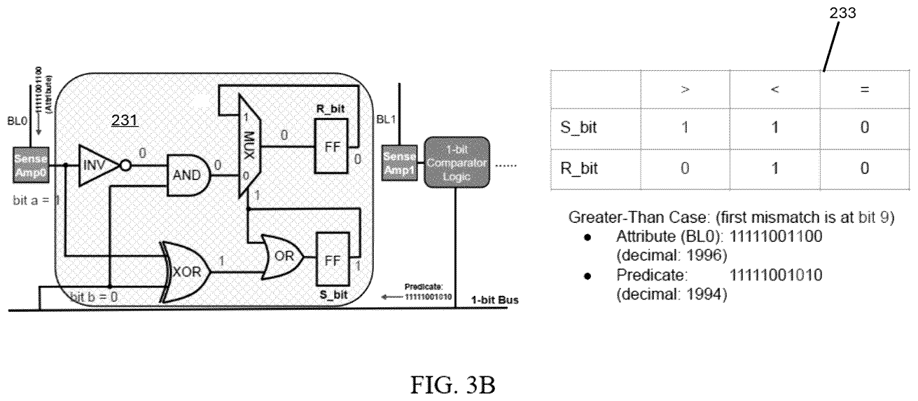

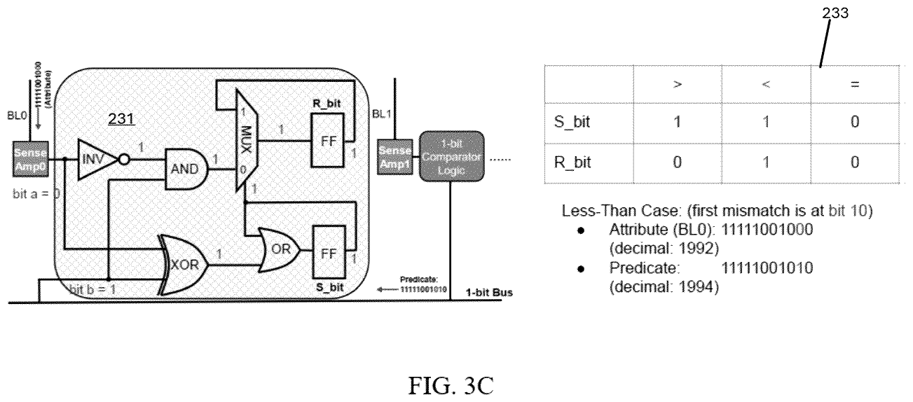

With reference to FIG. 2 and to FIGS. 3A-3C, a sub-array-level DRAM-PIM filtering architecture 201 is provided to accelerate OLAP queries. The sub-array-level DRAM-PIM filtering architecture 201 includes a DRAM chip 210 including multiple memory banks 220. As above, the sub-array-level DRAM-PIM filtering architecture 201 can further include a memory controller 240, which is coupled to the DRAM chip 210 and which can include a de-interleaving unit (to be described below) configured to swizzle bytes in each word such that an entirety of each word is stored on the DRAM chip 210. Each memory bank 220 includes multiple sub-array 221 pairs, where each sub-array 221 has data stored thereon in a vertical layout, with each bit stored in a different row and in a same column of the sub-array 221, and a per-bank global data bus 222, by which data of one sub-array 221 at a time flows relative to the memory bank, a sense amplifiers 223. Each of the multiple sub-array 221 pairs includes a sub-array-level filtering unit (SFU) 230. The SFU 230 includes a bit-serial comparison circuit 231 for each bitline (BL) in the subarray (see FIGS. 3A-3C) that is configured to perform filtering operations with respect to the associated one of the multiple sub-array 221 pairs.

The bit-serial comparison circuit 231 is configured to compare an attribute against a filtering predicate in a bit-serial manner, starting from a most significant bit (MSB) to a least significant bit (LSB). The bit-serial comparison circuit 231 is configured to perform a relational comparison between a block of table entries and a filtering predicate value whereby an attribute is compared against a filtering predicate in a bit-serial manner, starting from the MSB to the LSB. Before the first row activation, set bit (S_bit) flip flops and register bit (R_bit) flip flops are reset to zero. Once a mismatch is detected between first and second input bits (bit a and bit b), the set bit goes to high and latches itself and the current register is locked in to represent a final comparison result. After all n sequential row activations (n=bit length, e.g., n=11), the final values of the set bit and the register S_bit and R_bit determine the comparison outcome using the logic in truth table 233.

As shown in FIG. 3A, the bit-serial comparison circuit 231 is configured to handle an equal-to case characterized in that there is no mismatch through all bits. That is, an attribute (BLO): 11111001010 (decimal: 1994) and a filtering predicate (1-bit BUS): 11111001010 (decimal: 1994). In each row activation, if bit a (attribute) matches bit b (filtering predicate), both S_bit and R_bit remain 0. When a=b, all logic paths maintain S_bit=0, R_bit=0 and, if all bits match across n sequential row activations (n=bit length), the result is equal (S=0, R=0), according to the truth table 233.

As shown in FIG. 3B, the bit-serial comparison circuit 231 is configured to handle a greater-than case characterized in that a mismatch exists (i.e., the first mismatch is at bit 9; attribute (BLO): 11111001100 (decimal: 1996) and filtering filtering predicate: 11111001010 (decimal: 1994). For a current clock cycle (i.e., bit 9), the mismatch is detected indicating a valid result can be derived and that no more updating is required. That is, in the current cycle, a mismatch between a and b (a+b) is detected where specifically a=1 and b=0. This condition causes the logic to set S_bit=1, initiating the stop signal. At the same time, the multiplexer selects the output from the AND gate (since S_bit hasn't latched yet). The condition a=1 and b=0 drives R_bit=0, indicating a potential “greater-than” result. Following clock cycles, the result is latched after the mismatch and, in the subsequent clock cycles, the now-active S_bit=1 is fed into the OR gate, causing S_bit to remain latched at 1 and, with S_bit=1, the multiplexer switches to read from the R_bit instead of evaluating new inputs. This mechanism ensures both S_bit and R_bit remain unchanged after detecting the mismatch (e.g. bit 9), effectively locking in the comparison result after the first mismatch. A final state is S_bit=1, R_bit=0→Attribute>Filtering Predicate.

As shown in FIG. 3C, the bit-serial comparison circuit 231 is configured to handle a less-than case characterized in that a mismatch exists (i.e., the first mismatch is at bit 10; attribute (BL0): 11111001000 (decimal: 1996) and filtering predicate: 11111001010 (decimal: 1994). That is, at the 10th bit in this example, a mismatch is detected where a=0 and b=1. This condition sets both S_bit=1 and R_bit=1. As explained above in the description of FIG. 3B, once the S_bit is set to high, it latches itself and the R_bit remains unchanged in the following clock cycles/row activations. The final state is S_bit=1, R_bit=1→Attribute<Filtering Predicate.

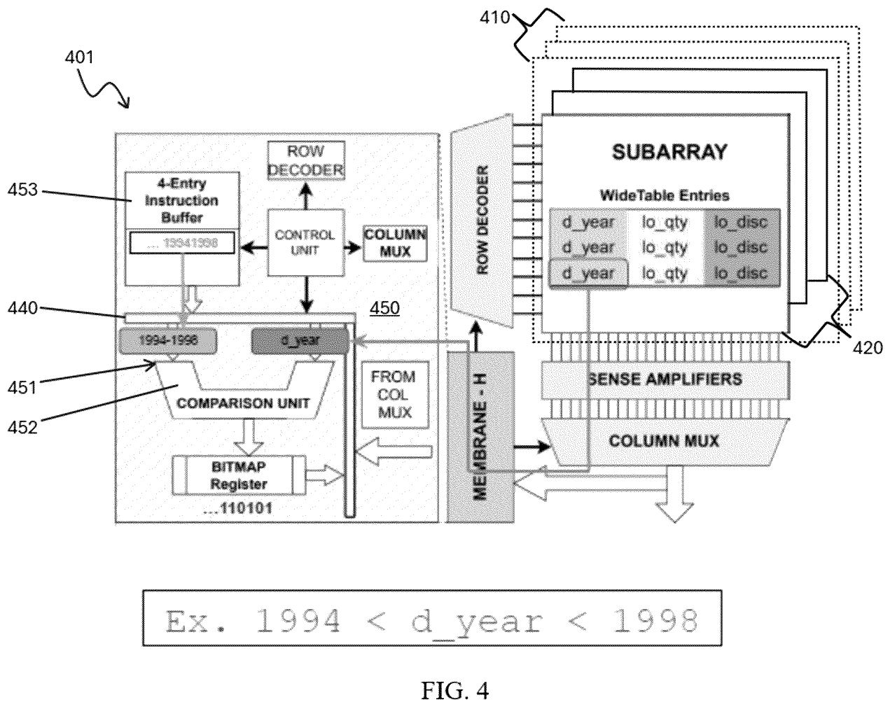

With reference to FIG. 4, a sub-array-level DRAM-PIM filtering architecture 401 is provided to accelerate database OLAP queries. The sub-array-level DRAM-PIM filtering architecture 401 includes a DRAM chip 410 including multiple memory banks 420. Each memory bank 420 includes multiple sub-arrays 430, each of which has data stored thereon in a horizontal layout, with each byte present in a same row of the corresponding one of the multiple sub-arrays 430, and a per-bank global data bus 440, by which data of one sub-array 430 at a time flows into and out of the memory bank 420. Each of the multiple sub-arrays 430 includes an SFU 450 including an element-serial bit-parallel comparison circuit 451 configured to perform filtering operations with respect to the associated one of the multiple sub-arrays 430. The sub-array-level DRAM-PIM filtering architecture 401 can also include a memory controller and a de-interleaving unit as described above with respect to FIGS. 1 and 2.

The element-serial bit-parallel comparison circuit 451 can include a comparison unit 452 and an instruction buffer 453. Individual data elements stored in the multiple sub-arrays are accessed sequentially and fed into the comparison unit 452. The instruction buffer 453 is configured to convey information as to which sub-array column is to be accessed for an operation and a type of comparison operation to be performed. In an exemplary operational case, individual “d_year” values stored in sub-arrays 430 are accessed sequentially and fed into the comparison unit 452. The comparison unit 452 takes in filtering predicate values (1994-1998) and the sub-array 430 values (d_year) and performs a comparison to produce a bitmap in which 1s indicate d_year values that evaluated to TRUE and 0s indicate those that evaluated to FALSE.

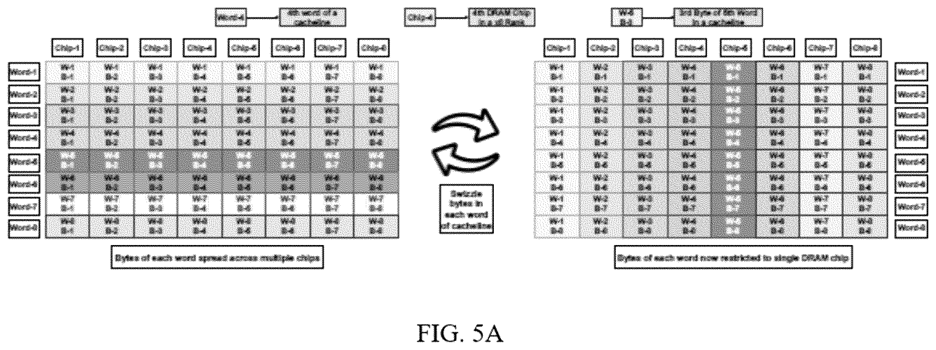

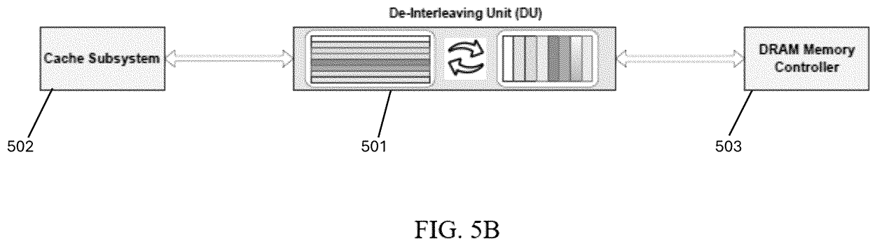

With reference to FIGS. 5A and 5B, the above-mentioned cache de-interleaving unit 501 is operably interposed between a cache subsystem 502 and a DRAM memory controller 503 (i.e., the memory controllers 140 and 240 of FIGS. 1 and 2). A purpose of the de-interleaving unit 501 is to swizzle the bytes in a single word such that they would reside in a single DRAM chip rather than be spread across multiple DRAM chips. In an operational case, a single cache-line from the cache subsystem 502 can be swizzled by the de-interleaving unit 501 before being written into DRAM by the DRAM memory controller 503 and a single cache-line read from DRAM by the DRAM memory controller 503 can be swizzled before being passed into the cache subsystem 502.

The de-interleaving unit 501 can thus be a critical component designed to optimize data organization within the DRAM hierarchy, ensuring compatibility with PIM architectures, such as those described above. In traditional DRAM configurations, data is interleaved across multiple DRAM chips within a rank, meaning that individual bytes of a single word are distributed across different chips. While this striping can improve memory bandwidth for conventional read/write operations, it poses challenges for PIM filtering, where operands often span multiple bytes and need to reside within a single DRAM chip for efficient processing. The de-interleaving unit 501 addresses this issue by swizzling the bytes of each word such that the entirety of the word is stored within a single DRAM chip. This reorganization ensures that PIM filtering units, such as the BFU 130 or the SFU 230 can access complete operands without requiring cross-chip data transfers.

Technical effects and benefits of the present disclosure are the provision of a bank-level DRAM-PIM filtering architecture and a sub-array-level DRAM-PIM architecture.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. A bank-level dynamic random access memory (DRAM) process-in-memory (DRAM-PIM) filtering architecture to accelerate database online analytical processing (OLAP) queries, comprising:
a DRAM chip comprising multiple memory banks, each memory bank comprising:
multiple sub-arrays in which data is stored in horizontal layouts, with each byte present in a same row of the corresponding one of the multiple sub-arrays;
a per-bank global data bus, by which the data of one sub-array at a time flows relative to the memory bank; and
a bank-level filtering unit (BFU) configured to perform filtering operations on data fetched from one of the multiple sub-arrays to the memory bank.

2. The bank-level DRAM-PIM filtering architecture according to claim 1, wherein the BFU comprises a reconfigurable comparator block (RCB), which is receptive of the data of the one sub-array at the time and filtering predicates, and which is configured to generate an output of elements of the data matching the filtering predicates.

3. The bank-level DRAM-PIM filtering architecture according to claim 2, wherein the RCB is supportive of equality checking.

4. The bank-level DRAM-PIM filtering architecture according to claim 2, wherein the RCB is supportive of range checking.

5. The bank-level DRAM-PIP filtering architecture according to claim 2, wherein the BFU further comprises a scratchpad memory to store the output as a bitmap.

6. The bank-level DRAM-PIP filtering architecture according to claim 2, wherein the BFU further comprises a multiple filtering predicate loop.

7. The bank-level DRAM-PIP filtering architecture according to claim 1, further comprising a memory controller coupled to the DRAM chip and comprising a de-interleaving unit configured to swizzle bytes in each word such that an entirety of each word is stored on the DRAM chip.

8. A sub-array-level dynamic random access memory (DRAM) process-in-memory (DRAM-PIM) filtering architecture to accelerate database online analytical processing (OLAP) queries, comprising:
a DRAM chip comprising multiple memory banks,
each memory bank comprising:
multiple sub-array pairs, each sub-array having data stored thereon in a vertical layout, with each bit stored in a different row and in a same column of the sub-array; and
a per-bank global data bus, by which data of one sub-array at a time flows relative to the memory bank,
each of the multiple sub-array pairs comprising a sub-array-level filtering unit (SFU) comprising a bit-serial comparison circuit configured to perform filtering operations with respect to the associated one of the multiple sub-array pairs.

9. The sub-array-level DRAM-PIM filtering architecture according to claim 8, wherein the bit-serial comparison circuit is configured to compare an attribute against a filtering predicate in a bit-serial manner, starting from a most significant bit (MSB) to a least significant bit (LSB).

10. The sub-array-level DRAM-PIM filtering architecture according to claim 9, wherein the bit-serial comparison circuit is configured to perform a relational comparison between a block of table entries and a filtering predicate value.

11. The sub-array-level DRAM-PIM filtering architecture according to claim 9, wherein the bit-serial comparison circuit is configured to:
reset set bit flip flops and register bit flip-flops to zero,
once a mismatch is detected between first and second input bits, a set bit goes to high and latches itself and a current register bit is locked, and
after all sequential row activations, final values of each set bit and each register bit determine a comparison output by reference to a truth table.

12. The sub-array-level DRAM-PIM filtering architecture according to claim 11, wherein the bit-serial comparison circuit is configured to handle an equal-to case.

13. The sub-array-level DRAM-PIM filtering architecture according to claim 11, wherein the bit-serial comparison circuit is configured to handle a greater-than case.

14. The sub-array-level DRAM-PIM filtering architecture according to claim 11, wherein the bit-serial comparison circuit is configured to handle a less-than case.

15. The sub-array-level DRAM-PIP filtering architecture according to claim 8, further comprising a memory controller coupled to the DRAM chip and comprising a de-interleaving unit configured to swizzle bytes in each word such that an entirety of each word is stored on the DRAM chip.

16. A sub-array-level dynamic random access memory (DRAM) process-in-memory (DRAM-PIM) filtering architecture to accelerate database online analytical processing (OLAP) queries, comprising:
a DRAM chip comprising multiple memory banks,
each memory bank comprising:
multiple sub-arrays, each having data stored thereon in a horizontal layout, with each byte present in a same row of the corresponding one of the multiple sub-arrays; and
a per-bank global data bus, by which data of one sub-array at a time flows relative to the memory bank,
each of the multiple sub-arrays comprising a sub-array-level filtering unit (SFU) comprising an element-serial bit-parallel comparison circuit configured to perform filtering operations with respect to the associated one of the multiple sub-arrays.

17. The sub-array-level DRAM-PIM filtering architecture according to claim 16, wherein the element-serial bit-parallel comparison circuit comprises a comparison unit.

18. The sub-array-level DRAM-PIM filtering architecture according to claim 17, wherein individual data elements stored in the multiple sub-arrays are accessed sequentially and fed into the comparison unit.

19. The sub-array-level DRAM-PIM filtering architecture according to claim 17, wherein the element-serial bit-parallel comparison circuit further comprises an instruction buffer configured to convey information as to which sub-array column is to be accessed for an operation and a type of comparison operation to be performed.

20. The sub-array-level DRAM-PIP filtering architecture according to claim 16, further comprising a memory controller coupled to the DRAM chip and comprising a de-interleaving unit configured to swizzle bytes in each word such that an entirety of each word is stored on the DRAM chip.
